(19) United States
(12) Patent Application Publication
(10) Pub. No.: US 2009/0098996 A1
(43) Pub. Date: Apr. 16, 2009

(54) Dunnaging Apparatus and Method with Controlled Web Tension

(75) Inventors: Michael M. Metta, Wayne, NJ (US); Ian M. Donegan, Morristown, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 11/870,801

(22) Filed: Oct. 11, 2007

(51) Int. Cl. B31F 7/00; B31C 11/00

(52) U.S. Cl. 493/464; 492/28

(57) ABSTRACT

A dunnaging apparatus and method for controlling web tension are provided. The apparatus includes a frame that is configured to support at least one supply of a web of paper having a continuous length and a width. A paper forming device is configured to receive the web of paper in a substantially flat configuration and fold the web along at least one line extending generally along the length of the web to form a paper cushion of reduced width. At least one roller is rotatably mounted on the frame and configured to support the web of paper between the supply and the forming device. The roller is formed at least partially of foam so that an outer surface of the roller is elastically deformable and the roller is configured to provide a nonuniform cross-sectional shape across the width of the web according to variations in the tension in the web across the width of the web.

### BACKGROUND OF THE INVENTION

The present invention generally relates to an apparatus and method for controlling the tensions in a web, such as a continuous sheet of paper being processed in a paper dunnaging machine.

Paper dunnaging machines are conventionally used to form paper cushioning material, typically from a roll of stock paper. For example, FIG. 1 illustrates a paper dunnaging machine 1, such as the PackTiger™ Paper Cushioning System, available from Sealed Air Corporation of Elmwood Park, N.J. The machine 1 can form paper to create paper cushioning material that can be used, e.g., as dunnage between the inside surfaces of a box or other container and merchandise disposed in the container to protect the merchandise during shipping, handling, storing, and the like. The machine 1 generally operates by dispensing a web 2 having one or more sheets of paper from a supply roll 3 and folding the paper to create a continuous paper pad 4 that can be cut to desired lengths. The paper web 2 is typically flat as it is dispensed from the supply roll 3. That is, each sheet of the paper defines a straight line across its width between the opposite lateral edges 5, 6 of the web 2. The machine 1 folds the paper web 2 from the flat configuration to a folded configuration by folding the lateral edges 5, 6 of the continuous web 2 inward toward the midpoint of the width of the web 2 and/or crumpling some portions of the web 2. Relative to the flat web 2, the finished cushioning material 4 has a reduced width, an increased thickness, and a reduced density.

The machine 1 typically includes one or more cylindrical rollers 7 for supporting the paper web 2 along the paper feed path between the supply roll 3 and the dunnage forming portion 8 of the machine 1. Each roller 7 is configured to support the web 2 in its unfolded configuration, i.e., such that each sheet of the paper defines a straight line across its width between the opposite lateral edges 5, 6 of the web 2. As the paper rolls off of the roller 7, the lateral edges 5, 6 begin to fold inward. This change in configuration typically increases the stress in the paper, such that the stress in the paper is relatively higher at the lateral edges 5, 6 and relatively lower between the edges 5, 6. Further, the tension throughout the width of the web 2 can increase during certain modes of operation of the machine 1, such as when the operation of the machine 1 is beginning and the speed of the paper web 2 along the feed path is increasing. Excessive tension in the web 2 can result in undesired tearing of the web 2, thereby requiring stopping the operation of the machine 1 and refeeding the web 2.

In some cases, each roller 7 can be contoured to accommodate the change in configuration of the web that occurs. That is, each roller 7 can define a non-cylindrical shape having a reduced diameter proximate the lateral edges 5, 6 of the web 2 so that length of the feed path is reduced slightly at the lateral edges 5, 6 and the relatively greater tensions at the edges 5, 6 are reduced. In addition or alternative, each roller 7 can be adjustably mounted in the machine 1, e.g., so that an axis of the roller 7 can translate slightly toward or away from the dunnage forming portion 8 of the machine 1. The roller 7 can be biased toward the web 2 (e.g., away from the dunnage forming portion 8 of the machine 1 as shown in FIG. 1) so that, when the tension in the web 2 exceeds a predetermined level, the bias is overcome and the roller 7 is adjusted by the web 2 (e.g., toward the dunnage forming portion 8 of the machine 1 in FIG. 1), thereby temporarily reducing the tension. Although such variations to the machine 1 can decrease the likelihood of tearing of the web 2, they generally increase the complexity and cost of the machine 1.

Thus, while conventional paper dunnaging machines have proven useful, there exists a continued need for an improved machine and method for dunnaging. The improved machine and method should be capable of reducing the relative tensions in the web of paper and reduce the likelihood of tearing of the web.

### BRIEF SUMMARY OF THE INVENTION

The present invention provides dunnaging apparatuses and methods with controlled web tension, such as for reducing the tension in a paper web that is dunnaged to form a cushioning material so that the likelihood of tearing of the paper is reduced.

According to one embodiment of the present invention, the paper dunnaging system includes a frame that is configured to support at least one supply of a web of paper having a continuous length and a width. A paper forming device is configured to receive the web of paper in a substantially flat configuration and fold the web along at least one line extending generally along the length of the web to form a paper cushion of reduced width. At least one roller is rotatably mounted on the frame and configured to support the web of paper between the supply and the forming device. The roller is formed at least partially of foam so that an outer surface of the roller is elastically deformable and the roller is configured to provide a nonuniform cross-sectional shape across the width of the web according to variations in the tension in the web across the width of the web. According to one embodiment, the system includes at least two of the rollers, and each roller is configured to support a respective layer of the web of paper.

The roller can be configured to deform to a greater extent during an interval of acceleration of the web than during an interval of no acceleration of the web. First and second longitudinal portions of the roller corresponding to opposite edges of the web can be configured to be deformed to a greater extent than a third longitudinal portion of the roller that is between the first and second longitudinal portions during operation of the paper forming device. Each roller can be rotatably mounted to the frame with a longitudinal axis of the roller fixed to the frame so that the axis of the roller is configured to remain stationary during operation of the paper forming device. Alternatively, each roller can be adjustably mounted to the frame so that a longitudinal axis of the roller is configured to move during operation of the paper forming device.

According to one embodiment, the roller for support the web of paper includes a rigid core and a foam layer disposed on an outer surface of the core. An outer surface of the roller is elastically deformable and the roller is configured to provide a nonuniform cross-sectional shape across a width of the web according to variations in the tension in the web across the width of the web. For example, the foam layer can be formed of polyethylene with a density of between about 0.5 and 3 pounds per cubic foot, the foam layer can define a thickness of between about 0.25 inch and 4 inches, the foam layer can define an outer radius of at least about 2 inches, and/or the core and the foam layer can each define a length of at least about 20 inches.

According to another embodiment, a method for dunnaging paper includes supporting at least one supply of a web of paper having a continuous length and defining a width. The web is formed from a substantially flat configuration along at least one line extending generally along the length of the web to form a paper cushion with a width smaller than the web. The web of paper is supported against at least one rotatable roller, and the roller is formed at least partially of foam so that an outer surface of the roller elastically deforms and the roller provides a nonuniform cross-sectional shape across the width of the web according to variations in the tension in the web across the width of the web. For example, the roller can be provided with a rigid core and a foam layer disposed on an outer surface of the core. The foam layer can be provided with a density of between about 0.5 and 3 pounds per cubic foot of polyethylene, a thickness of between about 0.25 inch and 4 inches, an outer radius of at least about 2 inches, and/or a length of at least about 20 inches. The roller can be deformed to a greater extent during an interval of acceleration of the web than during an interval of no acceleration of the web, and/or first and second longitudinal portions of the roller corresponding to opposite edges of the web can be deformed to a greater extent than a third longitudinal portion of the roller between the first and second longitudinal portions. In some cases, the roller is rotatably mounted to the frame with a longitudinal axis of the roller fixed to the frame so that the axis remains stationary during the folding step. Alternatively, the roller can be adjustably mounted to the frame so that a longitudinal axis of the roller moves during the folding step. Two or more layers of the web can be provided from the supply, and each layer can be supported by and against a respective one of the rollers.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view illustrating a conventional paper dunnaging machine;

FIG. 2 is perspective view partially illustrating a paper dunnaging machine according to one embodiment of the present invention;

FIG. 3 is an elevation view partially illustrating the dunnaging machine of FIG. 2;

FIG. 4 is a cross-sectional view illustrating the dunnaging machine of FIG. 2, as seen along line 4-4 of FIG. 3;

FIG. 5 is a perspective view illustrating one of the rollers of the machine of FIG. 2;

FIG. 6 is an elevation view illustrating the roller of FIG. 5;

FIG. 7 is a cross-sectional view illustrating the roller of FIG. 5 along line 7-7 of FIG. 6; and

FIG. 8 is an elevation view illustrating the roller of FIG. 5 in an undeformed configuration and indicating (by dashed lines) a deformed configuration of the roller.

### DETAILED DESCRIPTION OF THE INVENTION

The present inventions now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

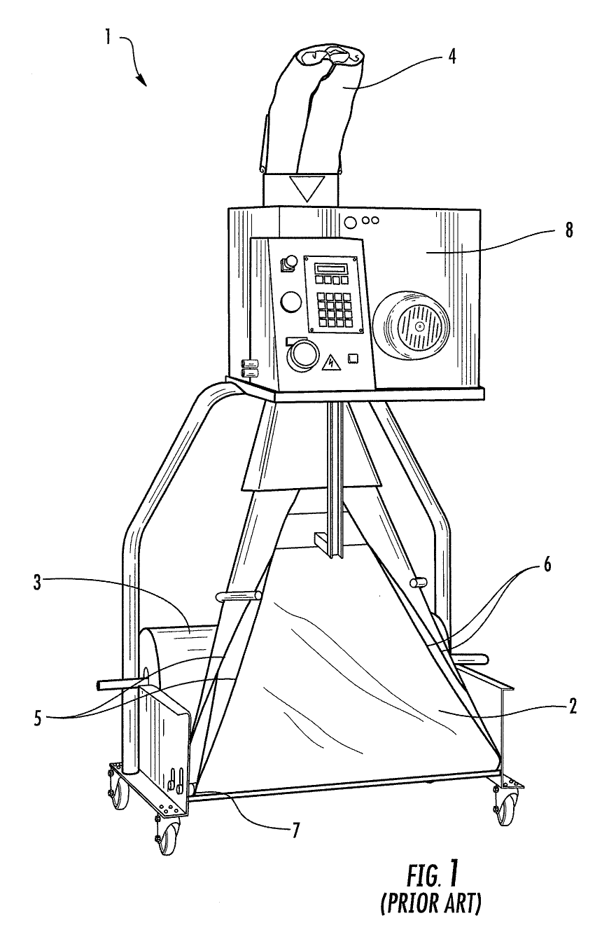

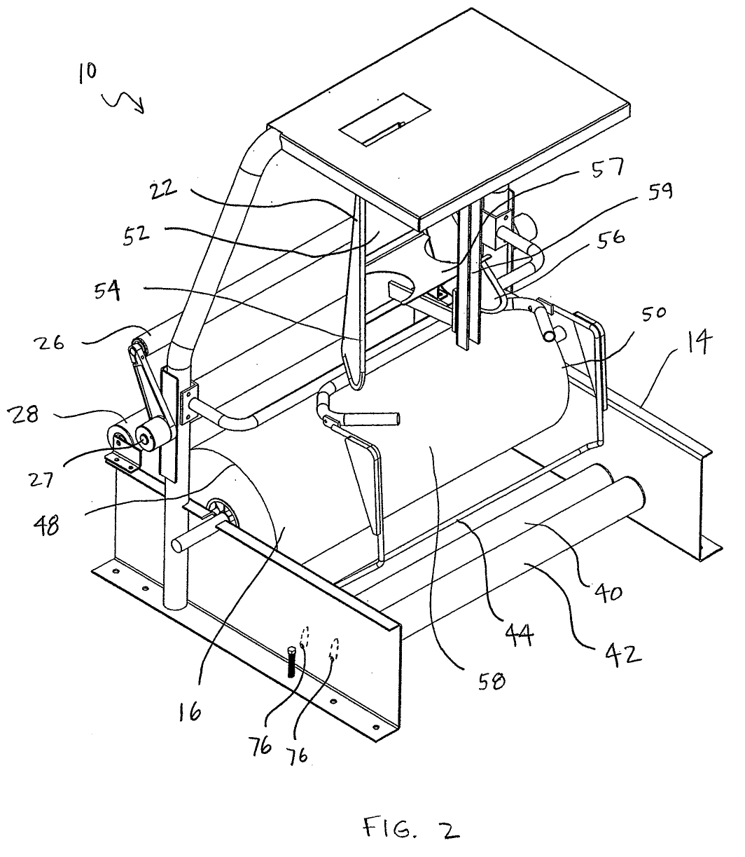

Referring now to the figures and, in particular, to FIGS. 2-4, there is shown a paper dunnaging machine 10 for forming paper cushioning material 12 (FIG. 4). The cushioning material 12 can be used, e.g., as dunnage that is packed around merchandise disposed in a box or other container so that the dunnage protects the merchandise during shipping, handling, storing, and the like. Except as described below, the machine 10 can be similar to a conventional dunnaging machine, such as the PackTiger™ Paper Cushioning System, available from Sealed Air Corporation of Elmwood Park, N.J., illustrated in FIG. 1, and can form paper cushioning material 12 that has a configuration similar to the continuous paper pad 4 shown in FIG. 1.

The machine 10 generally includes a frame 14 that supports one or more material supplies, such as a supply roll 16 of paper, which provides a continuous web 18 of paper used for forming the paper cushioning material 12. In the embodiment illustrated in FIG. 2, the supply roll 16 can be configured to simultaneously provide two continuous sheets or layers 18a, 18b of paper. The two layers 18a, 18b can be separate sheets that are overlapped and wound together on the roll 16 and used in combination to form the cushioning material 12.

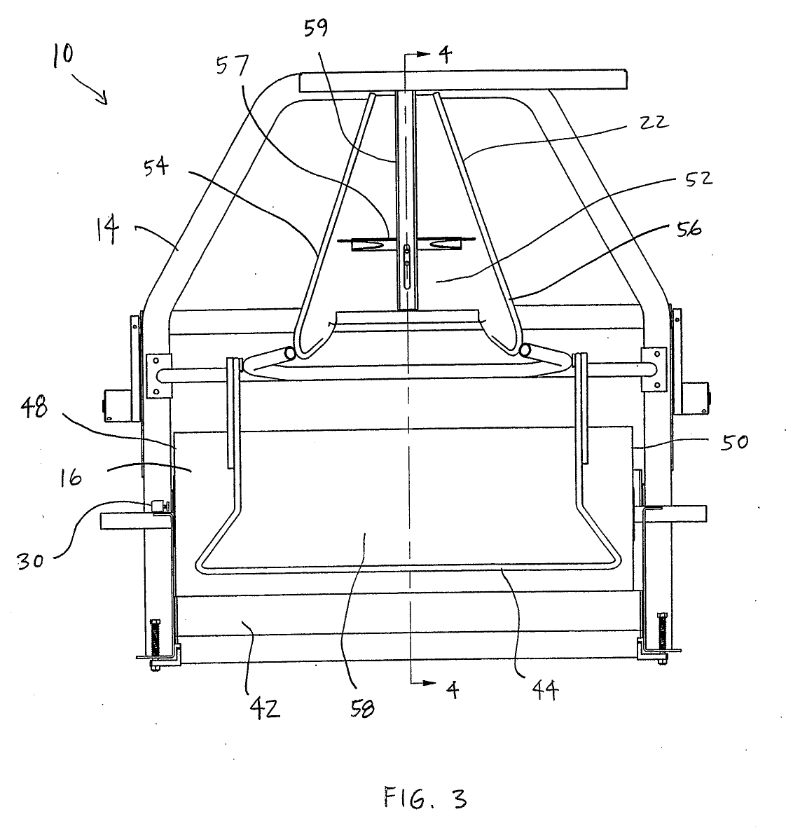

Similar to the configuration of the PackTiger™ Paper Cushioning System, the machine 1 of FIG. 1 has a generally vertical configuration. The supply roll 16 is mounted to the frame 14 near the bottom of the machine 10, below a paper forming device 20 that folds or otherwise forms the paper to the desired configuration of the paper cushioning material 12. The forming device 20 includes a funnel-like entry 22 that guides the paper into a dunnaging device 24. For purposes of illustrative clarity, the dunnaging device 24 is not shown in FIGS. 2 and 3. The dunnaging device 24, which is shown schematically in FIG. 4, can be a conventional device, such as the dunnaging device used in the forming portion 6 of the PackTiger™ Paper Cushioning System of FIG. 1 or other paper dunnaging machines.

The feed path of the paper web 18 is shown in FIG. 4. The supply roll 16 is rotatably mounted about a fixed axis to the frame 14 of the machine 10 and rotates as the web 18 is dispensed therefrom. As shown in FIG. 4, the roll 16 is configured to rotate counterclockwise, though other configurations can alternatively be used. After being dispensed from the supply roll 16, the web 18 passes around a first roller 26 and a second roller 28, both of which are typically rigid cylindrical members configured to rotate with the motion of the web 18. The rotary axis of each roller 26, 28 can be fixed to the frame 14 of the machine 10, or, in some cases, one or more of the rollers 26, 28 can be configured to adjust in position during operation of the machine 10. For example, the roller 26 can be configured to adjust (e.g., by virtue of rotation about a joint 27) toward the roller 28 during an operation of the forming device 20, and then away from the roller 28 between successive operations of the forming device 20. In this way, the feed path of the web 18 can be shortened during a forming operation, with the excess length of the web 18 along the path being used for the forming operation. Then, between forming operations, the length of the feed path can be increased as the roller 26 returns to the position shown in FIG. 4, with the supply roll 16 rotating between operations of the forming device 20 to supply the additional length of the web 18 required for the lengthening of the feed path.

A brake or other resistive device 30 can be configured to restrain the rotation of the supply roll 16 and/or the rollers 26, 28 to thereby restrain the motion of the web 18 and provide a desired tension on the web 18. For example, as shown in FIG. 3, the brake 30 can include an electromagnetic actuator, such as a solenoid, that is mounted to the frame 14 proximate the supply roll 16 and configured to selectively extend an arm defining a brake surface against an end of the supply roll 16 to thereby restrain the rotation of the roll 16.

The web 18 is further supported by deformable rollers 40, 42, which are provided along the feed path of the web 18 between the supply roll 16 and the entry 22 of the forming device 20. Any number of the rollers 40, 42 can be provided for supporting the one or more layers 18a, 18b of the web 18. In the embodiment illustrated in FIG. 4, the two layers 18a, 18b of the web 18 are separated by the two deformable rollers 40, 42, with a first layer 18a of the web 18 being directed to the forming device 20 from the first deformable roller 40, and a second layer 18b of the web 18 being directed to the forming device 20 from the second deformable roller 42. After passing around the respective rollers 40, 42, the two layers 18a, 18b can be held in contact with one another, e.g., by a guide rail 44, as the layers 18a, 18b are directed into the entry 22 of the forming device 20. A nip member 46, which can be a rotatable member or a fixed shaft, can be provided adjacent one of the rollers 40, 42 to define a nip through which the web 18 passes. In other embodiments, a single deformable roller 40, 42 can be provided for supporting one or more layers 18a, 18b of the web 18.

The dunnaging device 24 can include gears or other rotary members that grip the web 18, drive the web 18 along the feed path, and form the web 18 to the desired configuration of the cushioning material 12. The dunnaging device 24 folds the web, e.g., by rolling, turning, crumpling, or otherwise reconfiguring the web 18 so that the resulting cushioning material 12 has a reduced width and a reduced density relative to the original material of the web 18. The dunnaging device 24 typically includes one or more motors that provide the force for pulling the paper from the supply roll 16 to the forming device 20 and driving the paper through the forming device 20. In some cases, a blade or other cutting mechanism is provided in the dunnaging device 24 for cutting the paper cushioning material 12 at desired lengths as the cushioning material 12 exits the machine 10. The cutting mechanism can operate automatically, e.g., to cut the material 12 at predetermined intervals to form pieces of predetermined length, or upon an input from an operator. In either case, an electronic controller can be provided for controlling the operation of the machine 10 and/or providing a user interface for use by the operator.

The entry 22 of the forming device 20 guides the paper to a nonplanar configuration by folding or turning the lateral edges 48, 50 inward, i.e., generally along one or more lines or axes that extend generally along the length of the web 18. In particular, the entry 22 defines a first central portion 52 and two lateral portions 54, 56. Each of the lateral portions 54, 56 is disposed at an angle relative to the central portion 52 such that the portions 52, 54, 56 define a funnel-like space therebetween. Thus, as the web 18 slides along the entry 22 and is guided by the entry 22 into the forming device 20, the lateral edges 48, 50 of the web 18 are folded or turned inward to overlap the central portion 58 of the web 18, i.e., the portion of the web 18 defined inward along the width of the web 18 from the lateral edges 48, 50. A guide plate or other guide device 57 can be provided within the funnel-like space of the entry 22 to guide the folding motion of the web 18, and the guide device 57 and/or the entry 22 can be supported by a support member 59 that extends from the frame 14.

Along the feed path between the supply roll 16 and the deformable rollers 40, 42, the web 18 is typically in a flat configuration across its width, i.e., in a direction perpendicular to the feed path. In other words, a profile of each layer 18a, 18b of the web 18 across its width between the opposite lateral edges 48, 50 of the web 18 defines a substantially straight line. At approximately the positions 60, 62 at which each layer 18a, 18b of the web 18 winds off of the respective deformable roller 40, 42, the lateral edges 48, 50 begin to turn inward due to the guidance of the entry 22. Thus, the profile of the web 18 is no longer straight but instead is folded to generally define a c-shape, with the lateral edges 48, 50 being further turned as the web 18 advances into and through the entry 22. The term “fold” is used herein to refer to the reconfiguring of the layers of the web from the straight profile to a configuration having a nonlinear profile, and the term is not meant to require the formation of creases or contacting portions of the web. In one embodiment, the change in reconfiguration of the profile of the web 18 is similar to the shape of the web 2 shown in FIG. 1.

It is believed that this reconfiguration of the web 18 can result in an increase in tension and stress at the lateral edges 48, 50. That is, the tension at the lateral edges 48, 50 can be greater than the tension in the central portion 58 of the web 18. If the tension, or the difference in tension between the central portion 58 and the lateral edges 48, 50, becomes excessive, the paper web 18 can tear, thereby interrupting the operation of the machine 10. The likelihood for tearing can be increased during intervals when the overall tension on the web 18 is increased, such as when the speed of the web 18 along the path is being increased, e.g., upon start-up when the web 18 begins at rest and is quickly accelerated to an operation speed.

While the present invention is not limited to any particular theory of operation, it is believed that the deformability of the rollers 40, 42 reduces the likelihood of tearing or other destruction of the web 18 by reducing the tension at the lateral edges 48, 50 of the web 18. In particular, an outer surface 38 of each roller 40, 42 can be configured to deform according to the tension in the web 18 so that portions of the rollers 40, 42 in contact with the portions of the web 18 that are most highly tensioned are deformed to a greater extent than portions of the rollers 40, 42 that are in contact with the portions of the web 18 that are less tensioned. Thus, the deformable rollers 40, 42 can dampen the tensile force on the web 18, e.g., by spreading the force more evenly across the width of the web 18 and/or by reducing the magnitude of temporal variations in force, such as during start-up of the machine 10. The rollers 40, 42 can be deformed continuously to different magnitudes throughout the operation of the machine 10, though it is believed that the deformation is greatest during intervals of non-steady operation, such as during acceleration of the web 18. In some cases, the deformation of the rollers 40, 42 during steady operation (i.e., when the web 18 and forming device 20 are operating at a constant speed) can be negligible.

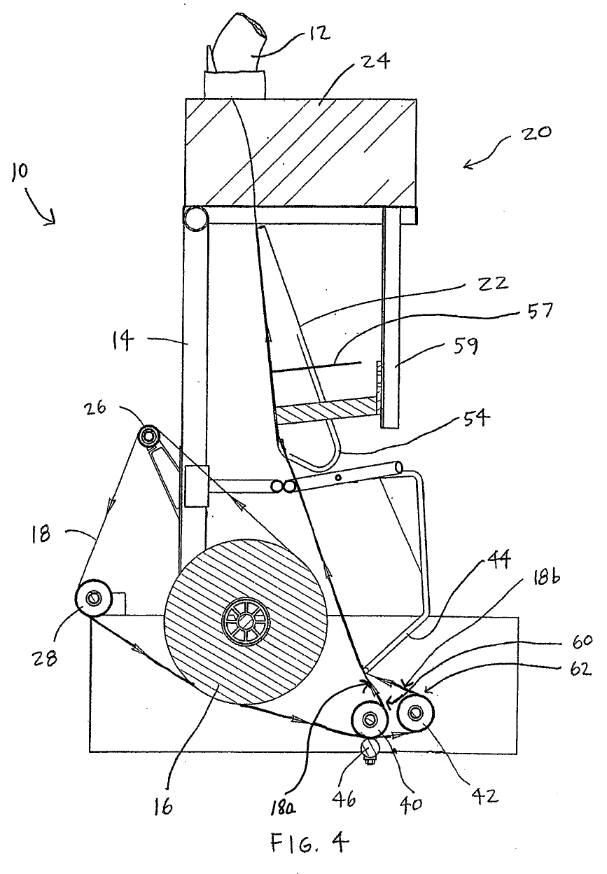

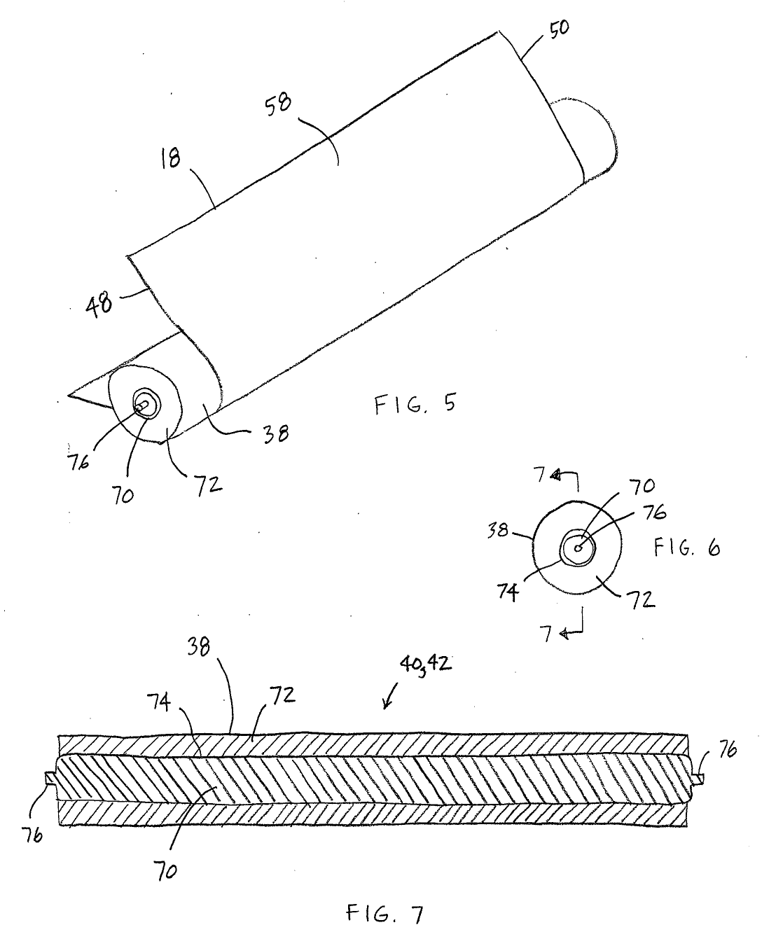

One of the deformable rollers 40, 42 is further illustrated in FIGS. 5-8. In the illustrated embodiment, each roller 40, 42 includes a rigid core 70 and a foam layer 72 disposed on the outer surface 74 of the core 70. For example, the core 70 of each roller 40, 42 can be formed of steel or other metals and can be a solid or hollow, tubular member. Cylindrical support ends 76 of each roller 40, 42 can be defined by the core 70 or by a shaft that is disposed through the core 70. The ends 76 can be rotatably supported by the frame 14, e.g., by disposing the ends 76 in holes, slots, or other apertures of the frame 14. In particular, the longitudinal axis of each roller 40, 42 can be fixed to the frame 14, e.g., by disposing the ends 76 in holes defined by the frame 14 that match the shape of the ends 76 (as shown in FIG. 2), so each roller 40, 42 can rotate about its longitudinal axis relative to the frame 14 but the longitudinal axis remains stationary during operation. Alternatively, the rollers 40, 42 can be adjustably mounted to the frame 14 so that the longitudinal axis of each roller 40, 42 can move during operation, e.g., by disposing the ends 76 in elongated slots defined by the frame 14, as shown by dashed lines in FIG. 2 and similar to the elongated slots of the machine 1 that support the roller 7 in FIG. 1. The foam layer 72 can be provided as a cylindrical sleeve that can be slid onto the core 70, and, in some cases, the sleeve can be replaceable on the core 70, e.g., so that the core 70 can be reused with a new foam layer 72 if the original foam layer 72 becomes worn. In any case, the outer surface 38 of the roller 40, 42 can be made elastically deformable so that the cross-sectional shape of the roller 40, 42 can vary according to variations in the tension in the web 18, while the core 70 can remain substantially undeformed during operation.

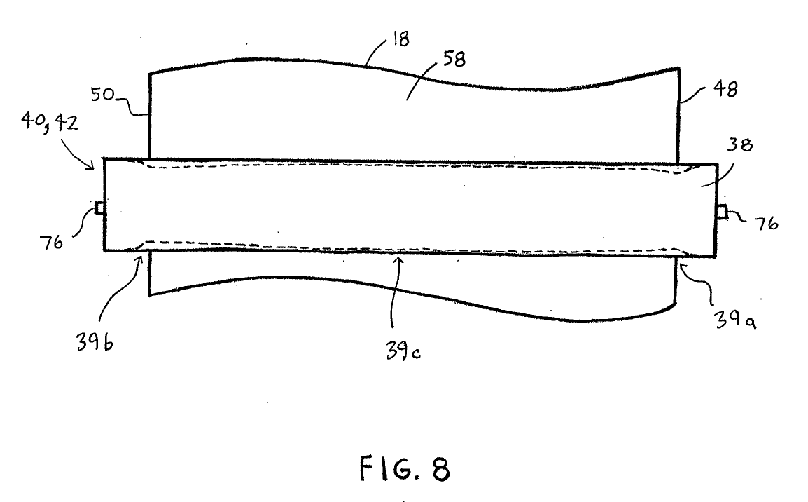

For example, the cross-sectional shape of the roller 40, 42 can be circular when there is no tension in the web 18, and the roller 40, 42 can be configured to provide a nonuniform cross-sectional shape across the width of the web 18 according to variations that occur in the tension in the web 18 across the width of the web 18. FIG. 8 illustrates one of the rollers 40, 42 in an undeformed configuration and indicates (by dashed lines) the deformed shape of the roller during a particular operation of the roller. The roller is deformed during operation as indicated by the dashed lines such that, where the lateral edges 48, 50 of the web 18 are subject to higher tension than the central portion 58 of the web 18, the corresponding portions of the deformable rollers 40, 42 (e.g., the first and second longitudinal end portions 39a, 39b of the rollers 40, 42 that are in contact with the lateral edges 48, 50) are compressed inward by the web 18, thereby reducing the circumference of the corresponding portions of the rollers 40, 42, reducing the length of the feed path at the lateral edges 48, 50 of the web 18, and reducing the tension in the lateral edges 48, 50. At the same time, if the central portion 58 of the web 18 is subject to lower tension, the corresponding portion of the roller 40, 42 (e.g., a third or central longitudinal portion 39c of the rollers 40, 42) in contact with the central portion 58 can be compressed inward by the web 18 to a lesser extent than at the lateral edges 48, 50, such that the circumference at the middle of the roller 40, 42 is greater than the circumference near the ends of the roller 40, 42 adjacent the lateral edges 48, 50 of the paper.

Various deformable materials can be provided for the rollers 40, 42 according to the desired characteristics of the rollers 40, 42. For example, the rollers 40, 42 can include materials such as rubbers, corks, plastics, and the like. For typical operation, it is believed that expanded foams provide sufficient deformation. In particular, in the embodiment illustrated in FIGS. 5-8, the foam layer 72 is formed of blown foam formed of a polymer, e.g., a polyolefin such as polyethylene. Foams of various materials and various densities can be used, e.g., according to the characteristics of the web 18, the machine 10, and the operation of the machine 10, such as the size and configuration of the supply roll 16; the material properties of the web 18; the desired tension on the web 18; the variations in speed of the web 18; the configuration of the web 18 in the feed path, including the turning of the lateral edges 48, 50; and the like. In some cases, the density of the foam layer 72 can be between about 0.5 and 3 pounds per cubic foot, such as between about 1 and 2 pounds per cubic foot, e.g., 1.66 pounds per cubic foot.

The dimensions of the deformable rollers 40, 42 can also be determined according to the characteristics of the web 18, the machine 10, and the operation of the machine 10. In particular, the length of the deformable rollers 40, 42 can be determined according to the length of the supply roll 16, e.g., so that the entire width of the web 18 is contacted and supported by the deformable portion of the roller 40, 42. For example, if the web 18 is about 20 inches wide, the core 70 and the foam layer 72 can each define a length of at least about 20 inches. If the roller 40, 42 includes a foam layer 72 on a rigid core 70, as described above, the foam layer 72 can be provided with a thickness that is sufficient to provide deformation to reduce the tension in the web 18 to a desired or predetermined amount. In one embodiment, the foam layer 72 can define a thickness of between about 0.25 inch and 4 inches, e.g., about 1 inch, and the foam layer 72 can define an outer radius of at least about 2 inches, e.g., about 4 inches.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A paper dunnaging system comprising:
a frame configured to support at least one supply of a web of paper having a continuous length and a width;
a paper forming device configured to receive the web of paper in a substantially flat configuration and fold the web along at least one line extending generally along the length of the web to form a paper cushion of reduced width; and
at least one roller rotatably mounted on the frame and configured to support the web of paper between the supply and the forming device, the roller formed at least partially of foam such that an outer surface of the roller is elastically deformable and the roller is configured to provide a nonuniform cross-sectional shape across the width of the web according to variations in the tension in the web across the width of the web.

2. A system according to claim 1 wherein the roller defines a rigid core and a foam layer disposed on an outer surface of the core.

3. A system according to claim 2 wherein the foam layer is formed of polyethylene with a density of between about 0.5 and 3 pounds per cubic foot.

4. A system according to claim 2 wherein the foam layer defines a thickness of between about 0.25 inch and 4 inches.

5. A system according to claim 2 wherein the foam layer defines an outer radius of at least about 2 inches.

6. A system according to claim 2 wherein the core and the foam layer each define a length of at least about 20 inches.

7. A system according to claim 1 wherein the roller is configured to deform to a greater extent during an interval of acceleration of the web than during an interval of no acceleration of the web.

8. A system according to claim 1 wherein the roller includes first and second longitudinal end portions configured to be in contact with lateral edges of the roller and a third central longitudinal portion disposed between the first and second longitudinal end portions and configured to be in contact with a central portion of the web and wherein the first and second end longitudinal portions of the roller are configured to deform to a greater extent than the third central longitudinal portion during operation of the paper forming device.

9. A system according to claim 1 wherein the roller is adjustably mounted to the frame such that a longitudinal axis of the roller is configured to move during operation of the paper forming device.

10. A system according to claim 1 wherein the roller is rotatably mounted to the frame with a longitudinal axis of the roller fixed to the frame such that the axis is configured to remain stationary during operation of the paper forming device.

11. A system according to claim 1 wherein the system comprises a second roller formed at least partially of foam and configured to support a respective layer of the web of paper.

12. A method for dunnaging paper, the method comprising:
supporting at least one supply of a web of paper having a continuous length and defining a width;
folding the web from a substantially flat configuration along at least one line extending generally along the length of the web to form a paper cushion with a width smaller than the web; and
supporting the web of paper against at least one rotatable roller, the roller being formed at least partially of foam such that an outer surface of the roller elastically deforms and the roller provides a nonuniform cross-sectional shape across the width of the web according to variations in the tension in the web across the width of the web.

13. A method according to claim 12, further comprising providing the roller comprising a rigid core and a foam layer disposed on an outer surface of the core.

14. A method according to claim 13 wherein providing the roller comprises providing the foam layer of polyethylene with a density of between about 0.5 and 3 pounds per cubic foot.

15. A method according to claim 13 wherein providing the roller comprises providing the foam layer defining a thickness of between about 0.25 inch and 4 inches.

16. A method according to claim 13 wherein providing the roller comprises providing the foam layer defining an outer radius of at least about 2 inches.

17. A method according to claim 13 wherein providing the roller comprises providing each of the core and the foam layer defining a length of at least about 20 inches.

18. A method according to claim 12 wherein supporting the web against the roller comprises deforming the roller to a greater extent during an interval of acceleration of the web than during an interval of no acceleration of the web.

19. A method according to claim 12 wherein supporting the web against the roller comprises deforming first and second longitudinal portions of the roller corresponding to opposite edges of the web to a greater extent than a third longitudinal portion of the roller between the first and second longitudinal portions.

20. A method according to claim 12 wherein supporting the web against the roller comprises providing the roller adjustably mounted to the frame such that a longitudinal axis of the roller moves during the folding step.

21. A method according to claim 12 wherein supporting the web against the roller comprises providing the roller rotatably mounted to the frame with a longitudinal axis of the roller fixed to the frame such that the axis remains stationary during the folding step.

22. A method according to claim 12, further comprising providing at least two layers of the web from the supply and supporting each layer against a respective roller formed at least partially of foam.

23. A roller for support a web of paper, the roller comprising:
a rigid core; and
a foam layer disposed on an outer surface of the core,
wherein an outer surface of the roller is elastically deformable and the roller is configured to provide a nonuniform cross-sectional shape across a width of the web according to variations in the tension in the web across the width of the web.

24. A roller according to claim 23 wherein the foam layer is formed of polyethylene with a density of between about 0.5 and 3 pounds per cubic foot.

25. A roller according to claim 23 wherein the foam layer defines a thickness of between about 0.25 inch and 4 inches.
